(19) United States
(12) Patent Application Publication
(10) Pub. No.: US 2021/0051454 A1
(43) Pub. Date: Feb. 18, 2021

(54) V2X DEVICE AND COMMUNICATION METHOD THEREOF

(71) Applicant: INDUSTRIAL TECHNOLOGY RESEARCH INSTITUTE, Hsinchu (TW)

(72) Inventors: Ching-Chun CHOU, Taipei City (TW); Hung-Yu WEI, Taipei City (TW); Hua-Lung TSAI, Taipei City (TW)

(73) Assignee: INDUSTRIAL TECHNOLOGY RESEARCH INSTITUTE, Hsinchu (TW)

(21) Appl. No.: 16/992,736

(22) Filed: Aug. 13, 2020

Related U.S. Application Data
(60) Provisional application No. 62/886,975, filed on Aug. 15, 2019.

(51) Int. Cl. H04W 4/40; H04W 4/06

(52) U.S. Cl. CPC H04W 4/40; H04W 4/06

(57) ABSTRACT

A V2X communication method includes: sending an assistance information from a V2X device to a user equipment (UE); performing first configuration on the UE; receiving a packet by the UE; performing upper layer mapping by the UE; sending a first traffic information from the UE to the V2X device; in response to a configuration request from the UE to the V2X device, performing second configuration on the UE by the V2X device; performing packet mapping by the UE; and performing layer processing by the UE.

This application claims the benefit of U.S. provisional application Ser. No. 62/886,975, filed Aug. 15, 2019, the subject matter of which is incorporated herein by reference.

### TECHNICAL FIELD

The disclosure relates in general to a vehicle-to-everything (V2X) device and a communication method thereof.

### BACKGROUND

Vehicle-to-everything (V2X) technology collects the information of the vehicle, the road and the environment using wireless communication and sensing technology. V2X technology includes vehicle-to-vehicle (V2V), vehicle-to-roadside unit (V2R), vehicle-to-infrastructure (V2I), vehicle-to-network (V2N), vehicle-to-pedestrian (V2P), vehicle-to-motorcycle (V2M) and vehicle-to-bus (V2T). Through V2X communication, different objects are allowed to communicate and share information to achieve smart collaboration and cooperation, and further implement smart traffic management and control, vehicle smart control and smart dynamic information service.

V2X technology is a technology critical to the smart traffic transportation system. V2X technology enables the vehicles to obtain real-time traffic status, road information, passenger information to increase driving security, reduce traffic congestion, increase traffic efficiency, and provide vehicle entertainment. V2X technology not only greatly increases traffic safety and reduces traffic accident rate, but further provides a technical direction and platform, which is low cost and is easy to implement, to the innovation of autopilot, smart traffic and V2X.

Currently, the application field of V2X technology includes security warning, driving risk management, emergency rescue, and mobile business platform.

To prevent accidents, the information of vehicle position, direction and speed are transmitted to other vehicles through network. Thus, after receiving the warning, the driver will be able to reduce the risk or the vehicle itself will take automatic safety measures such as speed reduction.

The nodes (such as vehicles, smart traffic lights, and roadside units) in the V2V communication can emit, receive and transfer the signals, and can collect remote traffic situation through V2V communication such that the driver can have enough time to take response.

Therefore, it has become a prominent task for the industries to provide a new technology to reduce the latency and increase the efficiency of V2X communication.

### SUMMARY

According to one embodiment, a vehicle-to-everything (V2X) communication method is provided. The method includes: transmitting an assistance information to a user equipment (UE) by a V2X device; performing a first configuration process on the UE; receiving a packet by the UE; performing an upper layer mapping process by the UE; transmitting a first traffic information to the V2X device from the UE; in response to a configuration request from the UE to the V2X device, performing a second configuration process on the UE by the V2X device; performing a packet mapping process by the UE; and performing a layer processing process by the UE.

According to another embodiment, a V2X device is provided. The device includes a controller and a signal transceiving unit. The controller is coupled to the signal transceiving unit and is configured to: transmit an assistance information to a user equipment (UE); perform a first configuration process on the UE; receive a first traffic information from the UE; and in response to a configuration request transmitted to the V2X device from the UE, perform a configuration process on the UE.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A and FIG. 1B are schematic diagrams of situations of use according to an embodiment of the present disclosure.

FIG. 2 is a flowchart of a V2X unicast communication method according to an embodiment of the present disclosure.

FIG. 3 is a flowchart of a V2X groupcast communication method according to an embodiment of the present disclosure.

FIG. 4 is a schematic diagram of a V2X device performing a cast type switching process.

FIG. 5 is a flowchart of a cast type switching process method according to an embodiment of the present disclosure.

FIG. 6 is a functional block diagram of a V2X device according to an embodiment of the present disclosure.

### DETAILED DESCRIPTION

Technical terms are used in the specification with reference to generally known terminologies used in the technology field. For any terms described or defined in the specification, the descriptions and definitions in the specification shall prevail. Each embodiment of the present disclosure has one or more technical features. Given that each embodiment is implementable, a person ordinarily skilled in the art can selectively implement or combine some or all of the technical features of any embodiment of the present disclosure.

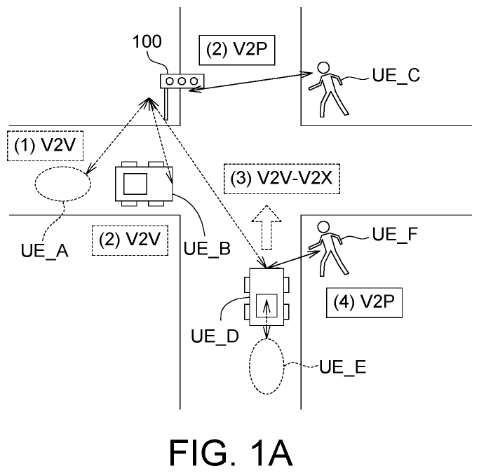

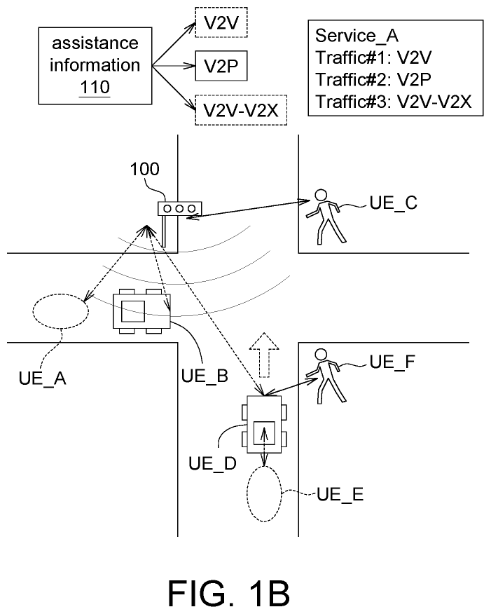

Referring to FIG. 1A and FIG. 1B, schematic diagrams of situations of use according to an embodiment of the present disclosure are shown. As indicated in FIG. 1A, the V2X device 100 communicates with multiple user equipments (UEs). For example, the V2X device 100 communicates with multiple user equipments UE_A˜UE_F. The user equipment UE_A˜UE_F are equipped with video, photography and V2X functions. The user equipment UE_A is such as a vehicle group; the user equipment UE_B is such as a vehicle; the user equipment UE_C is such as a passenger's smart mobile device; the user equipment UE_D is such as a vehicle; the user equipment UE_E is such as a vehicle group; and, the user equipment UE_F is such as a passenger's smart mobile device. The V2X device 100 communicates with the user equipment UE_A through V2V communication; the V2X device 100 communicates with the user equipment UE_C through V2P communication; the V2X device 100 communicates with the user equipment UE_D through V2V-V2X communication. FIG. 1A is only an exemplification, and the present disclosure is not limited thereto.

In an embodiment of the present disclosure, illustratively but not restrictively, the V2X device 100 can be realized by a roadside unit or a base station, a vehicle or passenger's smart mobile device. However, the present disclosure is not limited thereto, and other V2X device including a controller and a communication module can also be used as the V2X device 100 of the present disclosure.

In an embodiment of the present disclosure, the UEs can report the vehicle information or traffic information to the V2X device 100. The V2X device 100 collects and integrates the vehicle information or the traffic information transmitted from the UEs to generate an assistance information 110 as indicated in FIG. 1B. The assistance information 110 can be used to form an assistance information including the vehicle information or the traffic information transmitted from the UEs. For example, in a possible embodiment of the present disclosure, the assistance information includes at least one traffic information transmitted from the UEs. For example, the traffic information includes at least one or any combination of the video information transmitted from a vehicle camera, the audio information transmitted from a vehicle microphone, the road status information transmitted from a vehicle sensor, the vehicle position information transmitted from a vehicle GPS system, and the vehicle/passenger approaching signal or warning signal transmitted from a roadside unit.

In an embodiment of the present disclosure, the relation between the traffic information and the assistance information is specified to increase the allocation efficiency of the V2X resources.

In an embodiment of the present disclosure, the V2X device 100 transmits the assistance information 110 to the UEs, such that the UEs can receive a warning information transmitted from the V2X device 100 or can receive a video information from other UEs.

In an embodiment of the present disclosure, when accidents (such as car accidents) happened on the road, the UEs can receive warning information from the V2X device 100; then the UEs create a link with other UEs; and, the UEs can receive video information from other UEs to understand the road status and make early response to increase driving safety.

In an embodiment of the present disclosure, multiple types of traffic information are integrated in the same assistance information. The UEs receiving the assistance information (from the V2X device 100) can understand the traffic information of the assistance information. As indicated in FIG. 1B, the assistance information Service_A includes the first traffic information (Traffic #1) transmitted from the user equipment UE_A through V2V communication, the second traffic information (Traffic #2) transmitted from the user equipment UE_C through V2P communication, and the third traffic information (Traffic #3) transmitted from the user equipment UE_D through V2V-V2X communication. Then, when the user equipment UE_A needs the third traffic information (Traffic #3), the user equipment UE_A can create a link with the user equipment UE_D to receive the third traffic information (Traffic #3) from the user equipment UE_D.

In an embodiment of the present disclosure, the traffic information can be expressed as: Traffic #i={Scheduling info, Casting info, Allocation info, QoS information, Source, Destination}. The scheduling info includes persistent scheduling, dynamic scheduling and grant-free scheduling. The casting info includes unicast, groupcast and broadcast. The allocation info includes time parameter, frequency parameter, and radio bearer allocated parameter. The quality of service (QoS) information includes latency, reliability and other requirements. The source parameter represents the UE that provides service. The destination parameter represents the UE that receives service.

Besides, the assistance information may further include an indication parameter which indicates that the said traffic information belongs to the same assistance information.

In an embodiment of the present disclosure, the assistance information can be provided to the on-demand system information or, the assistance information can be provided by the V2X device 100 using broadcast.

For the vehicle network, the warning signal that can avoid car accidents or unsafe situations is very crucial, and therefore is broadcasted to all UEs in a low latency and high reliability manner. For the car accidents commonly happening at the crossroads, the car accident spot are out of the user's sight. Although the UE can receive the warning signal through vehicle network, probably the user still would prefer to receive the video information of car accident spot.

In an embodiment of the present disclosure, the warning signal and the traffic information (the video information that informs the user which UE possibly possesses car accident spot) are integrated in the same assistance information. According to the service type (such as the road status or the public safety service), the assistance information can show that the warning signal and the traffic information (the assistance information can inform the user which user possibly owns the video information of car accident spot) are already integrated in the same service. Therefore, in an embodiment of the present disclosure, the UE can promptly receive the warning signal, and if necessary, the UE can promptly receive the video information relevant to the car accident spot from the UE owning the video information of car accident spot.

In an embodiment of the present disclosure, the assistance information can be added to the resource allocation. Therefore, in an embodiment of the present disclosure, the relation between the traffic information and the assistance information is specified.

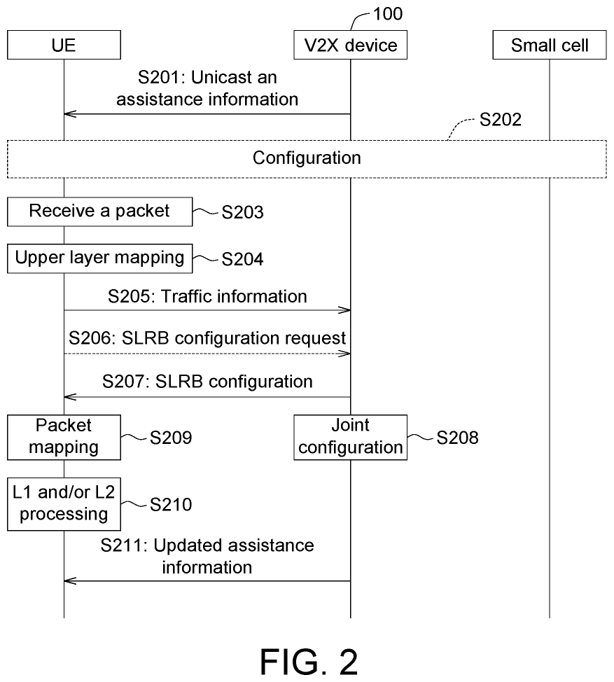

FIG. 2 is a flowchart of a V2X unicast communication method according to an embodiment of the present disclosure. Refer to FIG. 2. In step S201, an assistance information is transmitted to the UE from the V2X device 100. Illustratively but not restrictively, the assistance information is transmitted by the V2X device 100 through a sidelink (SL) control channel.

In step S202, a configuration process is performed on the UE. Illustratively but not restrictively, the configuration process is performed on the UE by a small cell. The small cell performs a service authorization process on the UE and a type 5 protocol converter (PC5) interface and a PC5 QoS profile. The small cell also provides the PC5 QoS profile of each PC5 QoS flow of the UE to the V2X device 100.

The content of the first configuration process performed in step S202 can be set according to the feedback of the traffic information. That is, the assistance information or the content of the first configuration process performed in step S202 can be set by the V2X device according to a known traffic information or a pre-allocated traffic information.

In step S203, a packet is received by the UE.

In step S204, an upper layer mapping process is performed by the UE. Details of step S204 include mapping the received packet to the PC5 QoS flow according to the PC5 QoS protocol, and transmitting the received packet to the access stratum (AS) relevant to the PC5 QoS flow Identifier.

In step S205, the traffic information is transmitted to the V2X device 100 by the UE.

In step S206, a sidelink radio bearer (SLRB) configuration request is transmitted to the V2X device 100 by the UE.

In step S207, an SLRB configuration process is performed on the UE by the V2X device 100. That is, in step S207, the V2X device 100 transmits an SLRB configuration parameter to the UE.

In step S208, joint configuration process is triggered by the V2X device 100. Step S208 is an optional step.

In step S209, a packet mapping process is performed by the UE. Illustratively but not restrictively, details of step S209 include creating SLRB configuration (SLRB relevant to the PC5 QoS flow) on the UE by an access stratum according to the configuration parameter received in step S207, and mapping the packet to the created SLRB.

In step S210, a first layer (L1) process and/or a second layer (L2) process are performed by the UE, and data are transmitted through a sidelink (SL) control channel.

In step S211, the updated assistance information is transmitted to the UE by the V2X device 100 through the sidelink (SL) control channel. Step S211 is an optional step. According to the traffic information transmitted from the UE, if the V2X device 100 determines to update the assistance information, then the V2X device 100 updates the assistance information and transmits the updated assistance information to the UE.

During the unicast communication of FIG. 2, the UE can periodically or non-periodically transmit the traffic information to the V2X device 100. In other possible embodiments of the present disclosure, the V2X device 100 can activate the transmission of the assistance information or the transmission of a content of the first configuration according to the periodically received traffic information.

In an embodiment of the present disclosure, when performing joint configuration process, the V2X device 100 can concurrently perform an SLRB configuration process on multiple UEs. For example, the V2X device 100 detects the traffic information to determine whether to trigger a joint configuration process. When the V2X device 100 receives a new traffic information (such as a warning signal), the V2X device 100 determines to trigger a joint configuration process. The joint configuration process is performed on the UEs such as the UEs belonging to the same service type or sharing similar QoS requirement. When performing the joint configuration process, the V2X device 100 will generate a new assistance information.

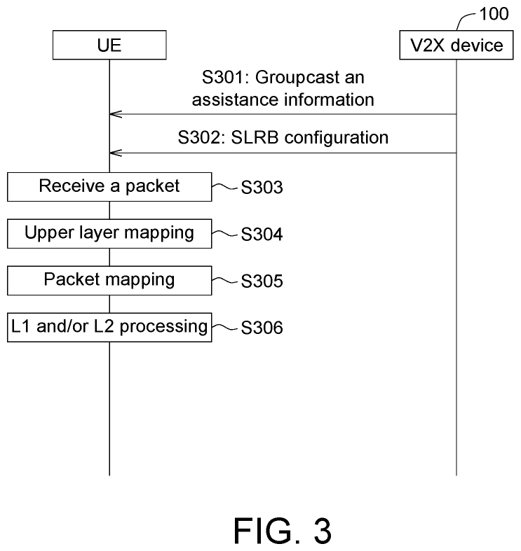

FIG. 3 is a flowchart of a V2X groupcast communication method according to an embodiment of the present disclosure. Refer to FIG. 3. In step S301, an assistance information is transmitted to the UE from the V2X device 100 using groupcasting. Illustratively but not restrictively, the assistance information is transmitted by the V2X device 100 through a sidelink control channel.

In step S302, an SLRB configuration process is performed on the UE by the V2X device 100 using groupcasting. That is, in step S302, an SLRB configuration parameter is transmitted to the UE by the V2X device 100 using groupcasting.

In step S303, a packet is received by the UE.

In step S304, an upper layer mapping process is performed by the UE. Details of step S304 include mapping the received packet to the PC5 QoS flow according to the PC5 QoS protocol, and transmitting the packet the access stratum to relevant to the PC5 QoS flow Identifier.

In step S305, a packet mapping process is performed by the UE. Illustratively but not restrictively, details of step S305 include creating SLRB configuration (SLRB relevant to the PC5 QoS flow) on the UE by an access stratum according to the configuration parameter received in step S302, and mapping the packet to the created SLRB.

In step S306, a first layer (L1) process and/or a second layer (L2) process are performed by the UE, and data are transmitted through a sidelink (SL) control channel.

During the groupcast communication of FIG. 3, the V2X device 100 can periodically or non-periodically transmit an assistance information to the UE.

When the UE receives the assistance information, the UE, through packet mapping process, can omit channel sensing, such that latency can be reduced, and efficiency can be increased.

According to the prior art, to search the needed the traffic information, the UE needs to scan neighboring UEs or use a frequency list. In an embodiment of the present disclosure, the UE can receive the assistance information transmitted from the V2X device, and therefore can search the needed traffic information without having to scan neighboring UEs or use a frequency list.

When the source UE providing the needed traffic information is located within the communication coverage range of the UE, the UE can detect the source index to create a link with the source UE so as to obtain the needed traffic information from the source UE. Here, the source UE refers to the UE providing the needed traffic information.

Conversely, when the source UE providing the needed traffic information is located outside the communication coverage range of the UE, the UE can be linked to the V2X device to obtain the needed traffic information from the source UE through the V2X device.

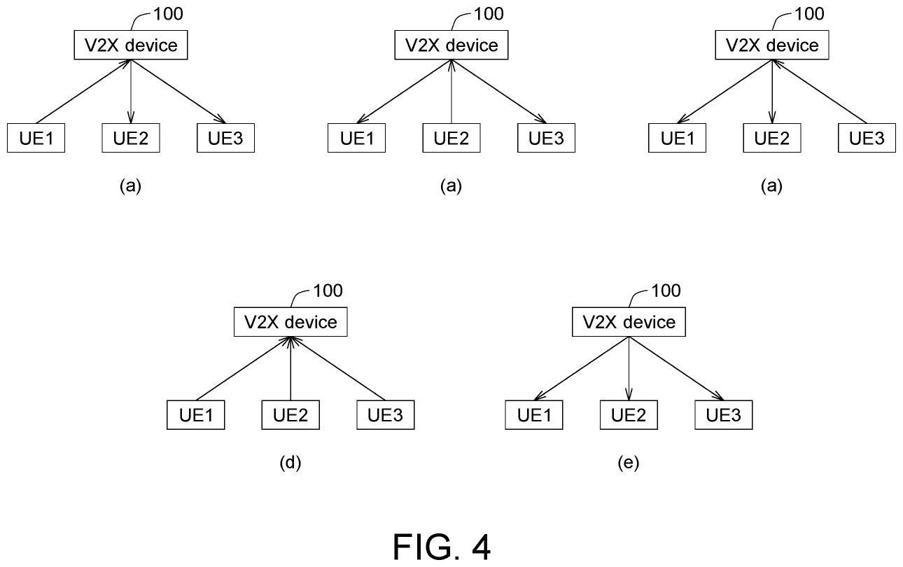

In an embodiment of the present disclosure, the V2X device can perform a cast type switching process (for example, the V2X device is switched to the groupcast type from the unicast type). FIG. 4 is a schematic diagram of a V2X device performing a cast type switching process. In situations (a)˜(c), the user equipment UE1˜UE3 respectively want to download needed traffic information from the V2X device 100; meanwhile, the casting type is unicast. When the V2X device 100 determines that the traffic information needed by the user equipment UE1˜UE3 belongs to the same assistance information (situation (d)), the V2X device 100 performs a cast type switching process (the V2X device 100 is switched to the groupcast type from the unicast type) and broadcasts the assistance information to the user equipment UE1˜UE3 using groupcasting (situation (e)).

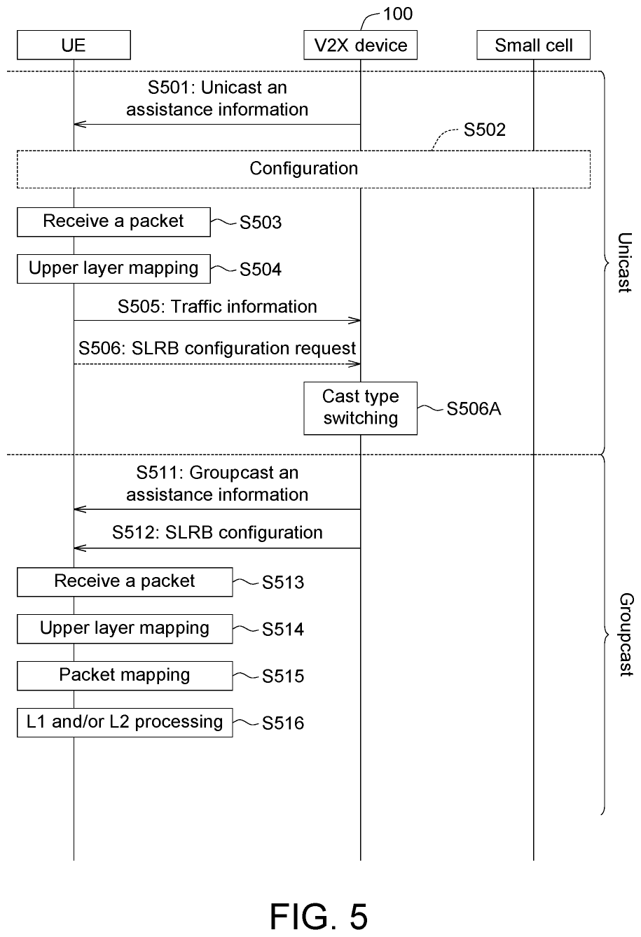

FIG. 5 is a flowchart of a cast type switching process method according to an embodiment of the present disclosure. Steps S501˜S506 of FIG. 5 basically are identical or similar to steps S201˜S206 of FIG. 2, and the similarities are omitted here.

In step S506A, whether to perform a cast type switching process is determined by the V2X device 100. Illustratively but not restrictively, details of step S506A include detecting the traffic information transmitted from multiple UEs by the V2X device 100. When at least two UEs request the same traffic information or when an emergent traffic situation (that is, existing traffic situation) or an emergent service requirement (that is, existing service requirement) appears (such as a warning signal or a car accident indication signal), the V2X device 100 determines to perform a cast type switching process (that is, the V2X device 100 is switched to a groupcast transmission mode from a unicast transmission mode) to allow all UEs located within the communication coverage range of the V2X device 100 to receive the assistance information transmitted from the V2X device 100.

After the cast type switching process is performed, steps S511˜S516 basically are identical or similar to steps S301˜S306 of FIG. 3, and the similarities are omitted here.

In an embodiment of the present disclosure, the V2X device 100 can perform a cast type switching process. The assistance information can be transmitted using groupcasting instead of unicasting to reduce latency.

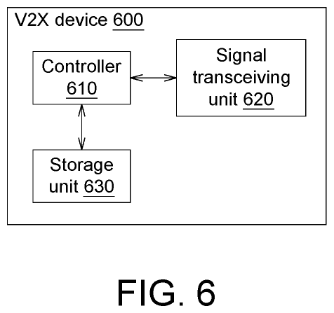

FIG. 6 is a functional block diagram of a V2X device according to an embodiment of the present disclosure. The V2X device 600 according to an embodiment of the present disclosure includes a controller 610, a signal transceiving unit 620 and a storage unit 630. The controller 610 is coupled to the signal transceiving unit 620 and the storage unit 630. The controller 610 controls the signal transceiving unit 620 and the storage unit 630 to implement the above embodiments.

In an embodiment of the present disclosure, the said information can be effectively shared among all users to increase crossroad security or accumulate environment perception.

In an embodiment of the present disclosure, the V2V and the V2X can be provided with assistance information. The resource allocation can cross multiple traffic types, such as audio type, video type, and data type, or can cross multiple networks, such as V2V, V2I, V2N, and V2X. In an embodiment of the present disclosure, with respect to the video sharing service, the video information can be provided by a vehicle sensor, the camera of a roadside unit or the camera of a passenger's smart mobile device.

In an embodiment of the present disclosure, an assistance information is provided to assist the operation of the MAC (physical) layer.

In an embodiment of the present disclosure, assistance information can be used to assist with sidelink resource allocation to increase efficiency and reduce latency. Thus, the present disclosure can improve configuration efficiency and accelerate cast type switching.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A V2X communication method, comprising:
transmitting an assistance information to a user equipment (UE) by a V2X device;
performing a first configuration process on the UE;
receiving a packet by the UE;
performing an upper layer mapping process by the UE;
transmitting a first traffic information to the V2X device from the UE;
in response to a configuration request transmitted to the V2X device from the UE, performing a second configuration process on the UE by the V2X device;
performing a packet mapping process by the UE; and
performing a layer processing process by the UE.

2. The V2X communication method according to claim 1, wherein, the V2X device transmits the assistance information to the UE using unicasting.

3. The V2X communication method according to claim 1, wherein, the V2X device transmits the assistance information through a sidelink control channel.

4. The V2X communication method according to claim 1, wherein,
the V2X device determines whether to update the assistance information according to the first traffic information transmitted from the UE; and
when the V2X device determines to update the assistance information, the V2X device updates and transmits the assistance information to the UE.

5. The V2X communication method according to claim 1, wherein, the UE periodically transmits the first traffic information to the V2X device.

6. The V2X communication method according to claim 5, wherein, the V2X device activates transmission of the assistance information or transmission of a content of the first configuration according to the periodically received traffic information.

7. The V2X communication method according to claim 1, wherein, the assistance information or a content of the first configuration is set by the V2X device according to a known traffic information or a pre-allocated traffic information.

8. The V2X communication method according to claim 1, wherein, the V2X device triggers a joint configuration process to perform a configuration process on a plurality of UEs concurrently.

9. The V2X communication method according to claim 8, wherein,
the V2X device detects the first traffic information to determine whether to trigger a joint configuration process; and,
the V2X device performs a configuration process on any two or more UEs.

10. The V2X communication method according to claim 9, wherein, the V2X device performs a configuration process on the UEs belonging to the same service type.

11. The V2X communication method according to claim 9, wherein, the V2X device performs a configuration process on the UEs sharing the same signal quality requirement.

12. The V2X communication method according to claim 1, wherein, the V2X device transmits the assistance information to the UE using groupcasting.

13. The V2X communication method according to claim 1, wherein,
when a source UE providing a second traffic information is located within a communication coverage range of the UE, the UE detects a source index to create a link with the source UE to obtain the second traffic information from the source UE; and
when the source UE providing the second traffic information is located outside the communication coverage range of the UE, the UE is linked to the V2X device to obtain the second traffic information from the source UE through the V2X device.

14. The V2X communication method according to claim 13, wherein, when the V2X device determines that a plurality of traffic information needed by a plurality of UEs belong to the same assistance information, the V2X device performs a cast type switching process to broadcast the assistance information to the UEs using groupcasting.

15. The V2X communication method according to claim 1, wherein, when the V2X device determines that an existing traffic situation or an existing service requirement appears, the V2X device performs a cast type switching process to broadcast the assistance information to the UEs using groupcasting.

16. The V2X communication method according to claim 1, wherein, the assistance information comprises the first traffic information transmitted from the UE, and the first traffic information comprises at least one or any combination of a video information, an audio information, a road status information, a vehicle position information, a vehicle/passenger approaching signal and a warning signal.

17. The V2X communication method according to claim 1, wherein, the first traffic information comprises a scheduling info, a casting info, an allocation info, a quality of service (QoS) information, a source parameter and a destination parameter.

18. A V2X device, comprising:
a controller; and
a signal transceiving unit coupled to the controller,
wherein, the controller is configured to:
transmit an assistance information to a user equipment (UE);
perform a first configuration process on the UE;
receive a first traffic information from the UE; and
in response to a configuration request transmitted to the V2X device from the UE, perform a configuration process on the UE.

19. The V2X device according to claim 18, wherein, the V2X device transmits the assistance information to the UE using unicasting.

20. The V2X device according to claim 18, wherein, the V2X device transmits the assistance information through a sidelink control channel.

21. The V2X device according to claim 18, wherein,
the controller determines whether to update the assistance information according to the first traffic information transmitted from the UE; and
when the controller determines to update the assistance information, the V2X device updates and transmits the assistance information to the UE.

22. The V2X device according to claim 18, wherein, the V2X device periodically transmits the first traffic information to the V2X device.

23. The V2X device according to claim 22, wherein, the V2X device activates transmission of the assistance information or transmission of a content of the first configuration according to the periodically received traffic information.

24. The V2X device according to claim 18, wherein, the assistance information or a content of the first configuration is set by the V2X device according to a known traffic information or a pre-allocated traffic information.

25. The V2X device according to claim 18, wherein, the V2X device triggers a joint configuration process to perform a configuration process on a plurality of UEs concurrently.

26. The V2X device according to claim 25, wherein,
the V2X device detects the first traffic information to determine whether to trigger a joint configuration process; and,
the V2X device performs a configuration process on any two or more UEs.

27. The V2X device according to claim 26, wherein, the V2X device performs a configuration process on the UEs belonging to the same service type.

28. The V2X device, wherein according to claim 26, the V2X device performs a configuration process on the UEs sharing the same signal quality requirement.

29. The V2X device according to claim 18, wherein, the V2X device transmits the assistance information to the UE using groupcasting.

30. The V2X device according to claim 18, wherein,
when a source UE providing a second traffic information is located within a communication coverage range of the UE, the UE detects a source index to create a link with the source UE to obtain the second traffic information from the source UE; and
when the source UE providing the second traffic information is located outside the communication coverage range of the UE, the UE is linked to the V2X device to obtain the second traffic information from the source UE through the V2X device.

31. The V2X device according to claim 18, wherein, when the V2X device determines that a plurality of traffic information needed by a plurality of UEs belong to the same assistance information, the V2X device performs a cast type switching process to broadcast the assistance information to the UEs using groupcasting.

32. The V2X device according to claim 18, wherein, when the V2X device determines that an existing traffic situation or an existing service requirement appears, the V2X device performs a cast type switching process to broadcast the assistance information to the UEs using groupcasting.

33. The V2X device according to claim 18, wherein, the assistance information comprises the first traffic information transmitted from the UE, and the first traffic information comprises at least one or any combination of a video information, an audio information, a road status information, a vehicle position information, a vehicle/passenger approaching signal and a warning signal.

34. The V2X device according to claim 18, wherein, the first traffic information comprises: a scheduling info, a casting info, an allocation info, a quality of service (QoS) information, a source parameter and a destination parameter.
